(19) United States
(12) Patent Application Publication
(10) Pub. No.: US 2022/0258959 A1
(43) Pub. Date: Aug. 18, 2022

(54) A BEVERAGE POD

(71) Applicant: SOCIETE DES PRODUiTS NESTLE S.A., Vevey (CH)

(72) Inventors: Nicolas Gres, Echenevex (FR); Christophe Sebastian Paul Hevdel, Chez-Le-Bart (CH); Pascal Girardin, Lausanne (CH)

(21) Appl. No.: 17/299,384

(22) PCT Filed: Dec. 3, 2019
(86) PCT No.: PCT/EP2019/083379

§ 371 Date: Jun. 3, 2021

(30) Foreign Application Priority Data
Dec. 4, 2018 (EP) 18210108.9

(51) Int. Cl. B65D 85/804; B65D 65/40; B65D 65/46; B32B 9/02; B32B 9/04; B32B 9/06; B32B 27/10; B32B 27/36; B32B 27/30; B65D 65/42

(52) U.S. Cl. CPC B65D 85/8043; B32B 2255/10; B65D 65/466; B32B 9/02; B32B 9/045; B32B 9/06; B32B 27/10; B32B 27/36; B32B 27/306; B65D 65/42; B32B 2307/7163; B32B 2307/558; B32B 2435/02; B32B 2255/26; B65D 65/40

(57) ABSTRACT

A pod has an inner volume in which beverage ingredients are stored and in which a beverage is produced when water is introduced inside. The pod includes a body where water is introduced and a closing lid where the beverage is dispensed. The pod is made of a biodegradable material. The body has a three-dimensional shape. The body can be made of a multilayer material including a paper layer and a plastic sealing layer with a tensile value at break preferably between 2% and 20%. The body also can be made of a monolayer material consisting of plastic with a tensile value at break in the range between 2% and 1000%. The closing lid is flat and made of a material having a puncture resistance value between 3 N/15 mm and 10 N/15 mm for an elongation between 1.5 mm and 3 mm.

### FIELD OF THE INVENTION

The invention concerns a pod comprising a beverage ingredient for the preparation of beverages. In particular, the invention concerns a pod for coffee preparation.

### BACKGROUND OF THE INVENTION

It is known to prepare coffee drinks by using a pod containing coffee in a dispensing machine. The pod has an inner volume in which coffee is stored and in which a beverage or drink is produced when water is introduced inside.

In an eco-responsible approach, some of the existing pods are made of compostable or biodegradable materials. For instance, document WO 2016/139554 A1 discloses a compostable coffee pod.

As explained in WO 2016/139554 A1, the characteristics that a material must possess so that it can be defined as “compostable” are established by the European Norm EN 13432 “Requirements for packaging recoverable through composting and biodegradation—Test scheme and evaluation criteria for the final acceptance of packaging”. According to this standard, the characteristics that a compostable material must present are listed below.
Biodegradability, i.e., the metabolic conversion of the compostable material into carbon dioxide. This property is measured with a standard testing method, namely prEN 14046 (also published as ISO 14855: biodegradability under controlled composting conditions). The level of acceptance is 90% biodegradability (with respect to cellulose) to be achieved in less than 6 months.
Disintegrability, i.e., the fragmentation and loss of visibility in the final compost (absence of visual contamination). Measured with a composting test on a pilot scale (prEN 14045). Samples of the test material are composted together with organic waste for 3 months. At the end, the compost is sifted with a 2-mm sieve. The mass of residue of the test material with a size greater than 2 mm must be less than 10% of the initial mass.
Absence of adverse effects on the composting process, verified with a composting test on a pilot scale.
Low levels of heavy metals and absence of adverse effects on the quality of the compost (e.g., reduction of the agronomic value and presence of ecotoxicological effects on plant growth). A plant-growth test (test OECD 208, modified) is carried out on samples of compost where degradation of the test material has occurred. No difference must be observed as compared to a control compost.
Other chemico-physical parameters that must not change after degradation of the material under study: pH; saline content; volatile solids; N; P; Mg; K.

It will be appreciated that a biodegradable material is not necessarily compostable because it must also disintegrate during a composting cycle. On the other hand, a material that breaks up during a composting cycle into microscopic pieces that are not then, however, totally biodegradable is not compostable.

WO 2016/139554 A1 discloses a cartridge or pod containing a dose of at least one substance that can be used for preparing a liquid product such as for example coffee. The pod comprises a body with a bottom wall through which the aforesaid liquid can flow out of the cartridge, and a closing lid or wall for closing the cartridge at the end opposite to said bottom wall. The bottom wall comprises a plastic compostable material having a perforability of not less than 12 N (according to ASTM F 1306 90, rate of penetration: 300 mm/min) and has a thickness ranging between 20 μm and 2 mm. In the prior art and especially in this document, it is explained that a preferential mode of use may envisage initial perforation of the bottom of the cartridge (i.e. perforation of the coffee product dispensing side) by interference with perforation tips of the coffee machine at the dispensing side, i.e., following upon an action of perforation of the bottom of the cartridge by the perforation tips, possibly even before the liquid water and/or steam starts flowing into the cartridge. In other terms, it is preferred that the dispensing side of the cartridge be perforated before, or together with the perforation of the closing lid which is on the water/steam entry side of the same cartridge.

However, for quality reasons, and especially in order to build a proper water pressure inside the cartridge, and therefore in order for the water pressure to extract most flavours from the coffee grounds, it may be preferable to achieve opening of the dispensing side of the cartridge after piercing of the water entry side of the cartridge. This enables to obtain a proper extraction of the coffee with a good ratio of coffee solids extraction and a good texture.

The invention seeks to provide a package for a coffee dose, preferably a compacted coffee dose, which is biodegradable, preferably compostable and which is able to associate in a functional structure, specific opening properties for a proper extraction.

### SUMMARY OF THE INVENTION

The invention concerns a pod with an inner volume in which a beverage ingredient is stored and in which a beverage is produced when water is introduced inside, said pod comprising a body through which water is to be introduced and a closing lid through which the beverage is to be dispensed, said closing lid being sealed on said body and defining therebetween said inner volume.

According to the invention, the pod is made of biodegradable materials, said body having a three-dimensional shape and said closing lid being flat, said closing lid being made of a material having a value of puncture resistance comprised between 3N/15 mm and 10N/15 mm for an elongation between 1.5 mm and 3 mm.

Thanks to the flat shape and the puncture resistance of the dispensing side, i.e. the closing lid, the latter can be open instantly when being pierced in the machine. Moreover, the elongation of the closing lid when pierced is controlled. The closing lid does not elongate too much. This instantaneous or snapping rupture with a small elongation enables a proper opening of the pod for a good extraction of the coffee.

The closing lid is made of a multilayer material, said multilayer material comprising at least a paper layer and a plastic laminate layer (or “sealing layer”).

In one embodiment, said multilayer material of said closing lid comprises a plastic layer, a paper layer and a plastic laminate layer (or “sealing layer”).

Paper and plastic laminate enable to have the desired properties with respect to the perforability. Moreover, it is possible to choose among the varieties of materials and in particular for the plastic laminate layer, it is possible to choose a biodegradable or a compostable material.

In one embodiment, said body is made of a stretchable material.

Using stretchable material for the body facilitates the formation of a three-dimensional shape with the exact desired shape and dimensions. Moreover, using stretchable material prevents the formation of wrinkles during the formation of the body.

According to the invention, said body can be made either of a multilayer material, said multilayer material comprising a paper layer and a plastic laminate layer, or of a monolayer material, said monolayer material being constituted of plastic. By laminate, it is meant a material that comprises at least two layers, which are laminated (i.e. attached by a lamination process) together.

Paper and plastic laminate enable to have the desired properties with respect to the stretchability.

In case the body is made of a multilayer material, said multilayer material has a tensile value at break at least equal to 2%, and preferably comprised between 2% and 20%.

In case the body is made of a monolayer material, said monolayer material is constituted of plastic and has a tensile value at break raging between 2% and 1000%.

In one embodiment, the pod is asymmetric with respect to a plane parallel to the closing lid.

In one embodiment, each of the body and the closing lid have an external surface, the external surface of each the body and the closing lid being coated with a protective layer of a polymeric compostable material.

The protective layer avoids that the closing lid sticks to the beverage machine. In particular, the protective layer is water repellent.

In one embodiment, said pod is tightly closed and is made of liquid-impermeable materials.

This avoids leakage of the coffee before piercing of the dispensing side of the pod.

### BRIEF DESCRIPTION OF THE DRAWINGS

Additional features and advantages of the present invention are described in, and will be apparent from, the description of the presently preferred embodiments which are set out below with reference to the drawing in which:

FIG. 1 is a perspective view of a pod according to the invention;

FIG. 2 is a perspective cut-away view of the pod of FIG. 1;

FIG. 3 is a graphic resuming results of puncture resistance tests of materials constituting the pod.

### DETAILED DESCRIPTION OF THE INVENTION

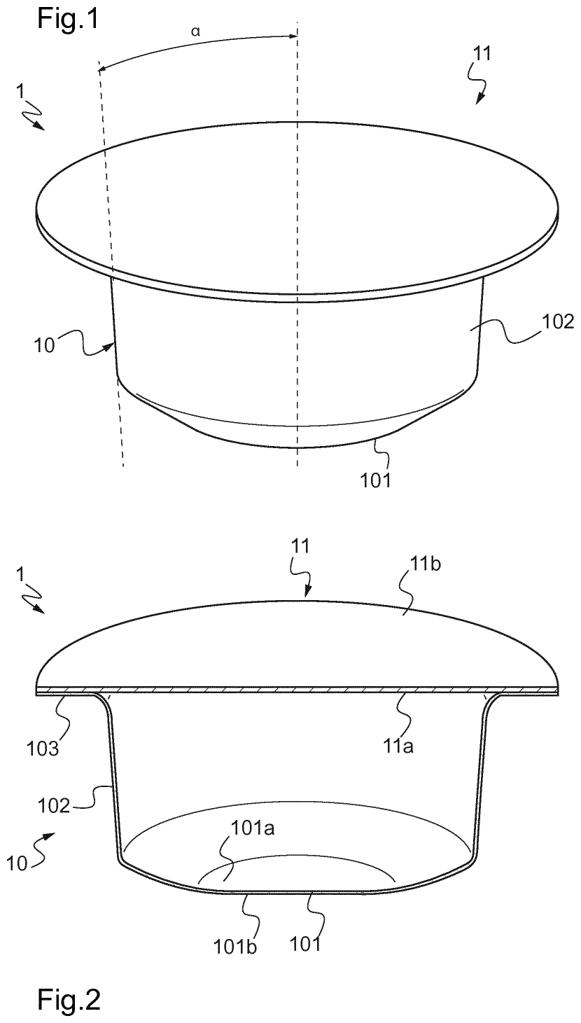

FIGS. 1 and 2 illustrate a pod 1 according to one embodiment of the invention.

The pod 1 comprises a body 10 and a closing lid 11. The closing lid 11 covers the body 10 so that the pod 1 is perfectly closed. The body 10 and the closing lid 11 form an inner volume in which a beverage ingredient, in particular coffee, is stored.

The body 10 has a three-dimensional shape. Three-dimensional shape shall mean that the body is “formed” or in other words that the body is not flat. The body 10 has a frustoconical shape extending around a revolution axis. The body 10 has a bottom wall 101 and a side wall 102. The side wall 102 is inclined of an angle of a with respect to the vertical revolution axis A. The angle α is inferior to 45° and preferably inferior to 30°. The angle α can be equal to 0°, in other terms the side wall 102 can extend substantially perpendicularly to the bottom wall 101. The body 10 comprises a peripheral edge 103 surrounding the side wall 102.

The body 10 has an outer surface and an inner surface. The inner surface is the surface in contact with the coffee. In particular, the bottom wall 101 has an inner face 101a and an outer face 101b.

The closing lid 11 is flat. The word “flat” shall mean that the closing lid 11 extends substantially in one plane. In other words, the closing lid 11 can extend in one plane or can be substantially convex or concave.

The closing lid 11 has an inner side 11a and an outer side 11b. The inner side 11a of the closing lid 11 faces the inner face 101a of the bottom wall 101.

The closing lid 11 is sealed on the body 10. In the described embodiment, the closing lid 11 is sealed on the peripheral edge 103. The closing lid 11 fits closely the body 10 so that a perfect sealing of the pod 1 is ensured. The pod 1 is impermeable to liquids and moisture. Preferably, the pod 1 is also impermeable to gas.

The bonding of the body 10 and the closing lid 11 can be obtained by heat sealing or ultra-sonic sealing.

The sealing between the closing lid 11 and the body 10 is airtight with a low leakage flow value. The leakage flow value is preferably inferior to 2 ml/min under 150 mbars inflating pressure during 30 seconds. The sealing between the closing lid 11 and the body 10 is also preferably tight under depressure of 600 mbars during 30 to 40 seconds.

The pod 1 is asymmetric with respect to a plane parallel to the closing lid 11.

The pod 1 is made of biodegradable materials. Preferably, the pod 1 is made of compostable materials. The pod 1 is intended to be “industrial” compostable or “home” compostable.

The body 10 is made of stretchable materials. The body 10 is formed starting from a flat blank, which is stretched and given a shape. Using stretchable materials for the body 10 allows the required stretching during the formation of the body, without breaking or tearing and without forming wrinkles on the peripheral edge 103. Moreover, thanks to stretchable materials it is possible to give the desired shape and dimensions to the body 10. For instance, the more the material is stretchable, the more it is possible to elongate the body and extend the dimensions of the body.

The body 10 has a tensile value at break at least equal to 2%. The tensile value at break defines the capacity of a material to withstand loads tending to elongate and characterizes here the stretchability. The more the tensile value at break is big, the more the material is stretchable. In this document, the tensile value at break is considered according to ISO 1924-2 for a speed of 20 mm/min.

During coffee production in a machine, water is introduced through the body 10. Water is injected though the bottom wall 101. For a good quality extraction of coffee, it was found that the opening of the pod 1 by means of needles must be smooth and easy.

The body 10 must thus open properly by the injection needles or blades and at the same time allow the required stretching during formation. The body is made of a material conferring such properties.

In an embodiment, the body 10 is made of a multilayer material. For example, the body 10 is made of a paper layer and a plastic sealing layer. Preferably, the paper layer forms the outer surface of the body and the plastic sealing layer forms the inside surface.

The paper is formable, i.e. it can be given a three-dimensional shape. The paper can have a grammage for example between 80 and 150 gsm (gram per square meter).

The plastic laminate can comprise a barrier polymer sandwiched between two compostable polymers. The barrier polymer can be for example Polyvinyl alcohol (PVOH). The compostable polymer can be for example chosen among polylactic acid (PLA), Polybutylene succinate (PBS), Polyhydroxyalkanoates (PHA), polybutylene adipate terephthalate (PBAT) and starch. The compostable polymer can also be composed of a polymer blend formed of PLA, PBAT, PLA and PBBS.

For example, the plastic laminate can be composed of a Polyvinyl alcohol (PVOH) sandwiched between two layers of polylactic acid (PLA).

The plastic laminate can have a thickness comprised between 20 and 100 μm and preferably between 35 and 50 μm. Formable paper substrate used inside the plastic laminate can have MD/CD (Machine direction and cross direction) stretching properties with a tensile value at break superior to 5%, along with isotropic or anisotropic paper characteristics.

The following table lists some possible compositions of the body having a multilayer material including a paper layer and a plastic sealing layer:

| | Plastic sealing layer | | | |
|---|---|---|---|---|
| | Compostable | Barrier | Compostable | |
| | polymer | polymer | polymer | Thickness |
| Paper | PLA | PVOH | PLA | 20-100 μm |
| layer | PBS | PVOH | PBS | 20-100 μm |
| 80-150 | PHA | PVOH | PHA | 20-100 μm |
| gsm | PBAT | PVOH | PBAT | 20-100 μm |
| | PBS | PVOH | PBS | 20-100 μm |
| | Starch | PVOH | Starch | 20-100 μm |
| | Polymer | PVOH | Polymer | 20-100 μm |
| | blend | | blend | |

The body 10 can also be made of a paper layer and a casein film. The casein film can have a thickness between 35-150 μm.

In an embodiment, the body 10 can be coated in its outer surface with a protective layer. The protective layer is made of a polymeric compostable material. For example, the protective layer of the body 10 can be made of PLA base, PBS base, milk casein base, PHA base, PBAT or Starch. The protective layer of the body 10 can also be made of a mix of these materials. The protective layer can comprise a barrier layer such as a PVOH layer.

For a multilayer material body, the tensile value at break is comprised between 2% and 20%. Preferably, the tensile value at break is equal to 15% for a paper-based body.

In another embodiment, the body 10 is made of a monolayer material. For example, the body 10 is made of compostable plastic.

For a monolayer material, the tensile value at break is comprised between 2% and 1000%. The value of 1000% for the tensile value at break is reached for “super stretchable” plastics for example.

During coffee production in a machine, the coffee is dispensed through the closing lid 11. The closing lid is pierced by means of truncated pyramid plates. For proper opening of the pod, and good coffee extraction, it was found that the opening of the dispensing side, here the closing lid, should be realised in an instant, as a result of a snapping rupture. The closing lid should tear but not elongate at the piercing.

To ensure the snapping rupture without a big elongation, it was found that the closing lid 11 should preferably have a puncture resistance comprised between 3N/15 mm and 10N/15 mm for an elongation at break comprised between 1.5 mm and 3 mm. For instance, the closing lid 11 can have a puncture resistance equal to 3N/15 mm and elongate of 1.5 mm when pierced. The closing lid 11 can also have a puncture resistance of 6.5 N/15 mm and elongate of 1.5 mm when pierced. The closing lid 11 can also have a puncture resistance of 10N/15 mm and elongate of 1.5 mm when pierced.

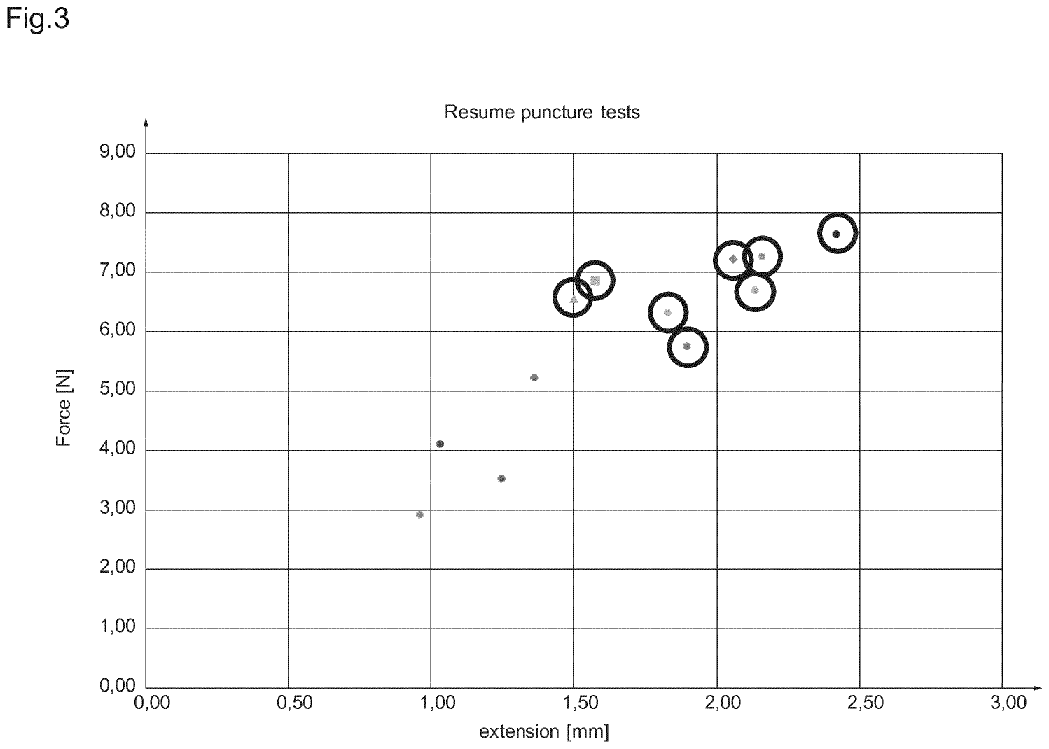

FIG. 3 shows examples of puncture resistance and elongation results obtained in tests. Examples of values enabling a snapping rupture with small elongation are circled, all of which were performed on samples of closing lids having a composition according to possible structures listed in detail thereafter, and in particular to those examples provided in the table below. The variations of puncture resistance shown in FIG. 3 are due to the variations of thicknesses in one or the other of the layers of the closing lid thus tested. Generally, FIG. 3 illustrates that closing lid structures that are manufactured according to the materials and thicknesses disclosed hereinafter, show a puncture resistance between 3N/15 mm and 10N/15 mm for an elongation at break comprised between 1.5 mm and 3 mm, which provides a snapping rupture for small elongation as required.

In this document, the puncture resistance values are considered according to the standard method ASTM 3420-91.

The closing lid 11 is made of a material conferring such properties. The closing lid 11 is made of a multilayer material.

In an embodiment, the multilayer material of the closing lid 11 is composed of a paper layer and a plastic laminate layer (or “plastic laminate sealing layer”, or “sealing layer”). Preferably, the paper layer forms the outer side 11b of the closing lid 11 and the plastic laminate layer (or “sealing layer”) forms the inner side 11a.

In another embodiment, the multilayer material of the closing lid 11 can be composed of a plastic layer, a paper layer and a plastic laminate layer (or “sealing layer”). Preferably, the plastic layer forms the outer side of the closing lid 11, the paper layer forms an intermediate layer, and the plastic laminate layer forms the inner layer of the closing 11 (i.e. the inner layer that is turned towards the internal compartment of the pod.

The paper layer of the closing lid 11 can have a code printing on it. The code serves as an identification of the pod, more precisely an identification of the type of ingredient contained inside the pod, and/or an identification of the characteristics of the pod, such as its volume, shape and/or size, or also the composition of its walls. This code is to be read or sensed, directly or indirectly by the beverage preparation machine into which the pod is functionally inserted, such that said machine can set the right preparation parameters as a function of the type of ingredient and pod that is worked therein.

The paper layer can have a grammage comprised between 20 gsm and 120 gsm.

To obtain a workable interaction with the pyramid plates of the machine when piercing the closing lid, the plastic laminate can have some specific characteristics.

The plastic laminate layer can have a thickness comprised between 10 μm and 100 μm. The plastic sealing laminate layer can be chosen among biaxially oriented polypropylene (BOPP), oriented polypropylene (OPP), polyethylene terephthalate (PET), biaxially oriented polylactic acid (BOPLA) and cellophane. In one preferred embodiment, the plastic laminate layer comprises a compostable bi-orientated film, more preferably produced on a cast stenter film process to obtain adequate performance with the machine when piercing. The compostable bi-orientated film has a thickness between 20 μm and 60 μm.

In an embodiment, the closing lid 11 can be coated (coating means that the thickness is less than 10 microns) in its outer side 11a with a protective layer, or its surface treated with a protective surface treatment. The protective layer is made of a polymeric compostable material. For example, the protective layer of the closing lid 3.1 can be a PLA (poly lactic acid) film, a cellulosic film (cellophane), a PBS (polybutylene succinate) film, a Micro Fibrillated Cellulose film. The protective layer can contain a barrier layer (for example a modified PVOH (polyvinyl alcohol) layer). The protective layer avoids that the closing lid 3.1 sticks to the beverage machine. In particular, the protective layer is water repellent. Preferably, if a code is printed on the paper layer, it can be read though the outer protective layer of the closing lid 11.

The following table lists some possible compositions of the closing lid 11 (in the left column of the table is listed the outer layer of the closing lid, then in the middle column is shown the intermediate layer of the closing lid, and then in the right column of the table is listed the inner layer of the closing lid):

| Plastic and/or | | Plastic laminate layer |
|---|---|---|
| protective layer | Paper layer | (or “sealing layer”) |
| PLA, thickness of | Paper of 30- | PLA coated, thickness |
| 5-40 μm | 100 gsm | of 10-40 μm |
| Surface treatment | Paper of 30- | PLA coated, thickness |
| (hydrophobic/hydrophilic) | 100 gsm | of 5-25 μm |
| or lacquer | | |
| Cellophane, thickness of | Paper of 30- | Cellophane coated, |
| 5-25 μm | 100 gsm | thickness of 10-40 μm |
| Surface treatment (water | Paper of 30- | Cellophane coated, |
| repellent, water resistant) | 100 gsm | thickness of 5-25 μm |
| or lacquer | | |

The paper specifications for both the body 10 and the closing lid 11 have been reformulated to match paper EU, FDA, China regulations for hot extraction end-use.

The properties of the pod having been described, the behaviour of the pod 1 in a beverage machine is now described.

The beverage machine according to one embodiment comprises two different types of liquid conduction channels. At the entry side of the machine, sharp needle-shaped water injectors are present. The machine also comprises a dispensing structure designed with a set of raised elements having evacuation channels between them. The raised elements are preferably truncated pyramids.

The water injectors pierce the bottom wall 101 of the body 10 when the pod 1 is introduced into a brewing cavity and the cavity is closed. The bottom wall 101 should be easy to pierce. This smooth and easy piercing of the bottom wall 101 is enabled for example by the materials used for the body 10 as explained above.

Then, the injection of water inside the coffee pod starts, and water pressure builds inside the pod, provoking swelling of the coffee mass, and expansion of the internal volume of the pod. The dispensing side (i.e. the closing lid 11) of the pod 1 is thus pressed against the dispensing structure of the machine. Because the tips of the pyramids are not sharp but truncated, they do not pierce the closing lid 11 immediately when the brewing cavity closes, but only when a sufficient pressure inside the coffee pod 1 is reached which presses the closing lid 11 sufficiently against the tips. Generally, this condition is obtained when internal pod pressure is above 4 bar. In optimal conditions for coffee extraction, the opening pressure inside the coffee pod should be at least 8 bar.

The closing lid 11 is pierced instantaneously once the pressure is sufficiently high.

The invention proposes thus a pod having interesting properties, in particular for the closing lid and enabling a good extraction of coffee. The coffee pod indeed provides top quality coffee in the cup, with a very good ratio of coffee solids extraction, which means that the coffee is not “under-extracted” (i.e. which would give not enough flavours, and therefore flat notes in the cup), nor is it “over-extracted” in order to prevent off-notes like burnt flavours, or bitter taste. Furthermore, a proper extraction provides a generous, long-lasting crema on the top of the liquid coffee, with fine bubbles and light brown colour.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A pod with an inner volume in which a beverage ingredient is stored and in which a beverage is produced when water is introduced inside, the pod comprising a body through which water is to be introduced and a closing lid through which the beverage is to be dispensed, the closing lid being made of a multilayer material, the multilayer material comprising at least paper layer and a plastic laminate sealing layer and sealed on the body and defining therebetween the inner volume, the pod being made of biodegradable materials, the body having a three-dimensional shape and the closing lid being flat, the closing lid is made of a material having a value of puncture resistance comprised between 3N/15 mm and 10N/15 mm for an elongation between 1.5 mm and 3 mm, and in that the body is made of a material selected from the group consisting of either:
a multilayer material, the multilayer material comprising a paper layer and a plastic sealing layer, having a tensile value at break at least equal to 2%, and preferably comprised between 2% and 20%, and
a monolayer material, the monolayer material being constituted of plastic having a tensile value at break ranging between 2% and 1000%.

2. A pod according to claim 1, wherein the multilayer material of the closing lid comprises a plastic layer, the paper layer and the plastic laminate sealing layer.

3. A pod according to claim 1, wherein the body is made of a stretchable material.

4. A pod according to claim 1, wherein the pod is asymmetric with respect to a plane parallel to the closing lid.

5. A pod according to claim 1, wherein each of the body and the closing lid have an external surface, the external surface of each the body and the closing lid being coated with a protective layer of a polymeric compostable material.

6. A pod according to claim 1, wherein the pod is tightly closed and is made of liquid-impermeable materials.
